(19) United States
(12) Patent Application Publication
(10) Pub. No.: US 2023/0145159 A1
(43) Pub. Date: May 11, 2023

(54) TIRE RUBBER COMPOSITION WITH BALANCED REINFORCEMENT NETWORK

(71) Applicant: The Goodyear Tire & Rubber Company, Akron, OH (US)

(72) Inventors: Roberto Cerrato Meza, North Canton, OH (US); Warren James Busch, North Canton, OH (US)

(21) Appl. No.: 17/454,126

(22) Filed: Nov. 9, 2021

(51) Int. Cl. C08L 9/06; C08L 7/00; C08F 136/08; C08K 3/06; C08K 3/04; C08K 3/36; C08K 5/09; C08L 91/00; C08K 5/43; B60C 1/00

(52) U.S. Cl. CPC C08L 9/06; B60C 1/0016; C08F 136/08; C08K 3/04; C08K 3/06; C08K 3/36; C08K 5/09; C08K 5/43; C08L 7/00; C08L 91/00; B60C 2200/06; C08L 2205/03; C08L 2205/025

(57) ABSTRACT

A sulfur-curable rubber composition for incorporation into tires comprises, based on 100 parts by weight of elastomer (phr): (A) at least three diene elastomers each being a different rubber material, a first elastomer being characterized by a high molecular weight in a range of from about 300,000 to about 500,000 and a second elastomer being characterized by a molecular weight in the range of from about 250,000 to 350,000; the at least three elastomers each comprising between 25 and 40 phr; and (B) a reinforcement network comprising a balance of carbon black to silica in about a 3:1 to about 4:1 ratio.

### FIELD OF THE INVENTION

The present disclosure relates to a rubber formulation for a tire component and is described with particular reference thereto. However, it is to be appreciated that the present exemplary embodiments are amenable for incorporation in other rubber products and for like applications.

### BACKGROUND OF THE INVENTION

Tire wear and abrasion is the unavoidable loss of rubber material during rolling and sliding contact of tires with the road. Tires, in particular truck tires intended for use under heavy loads, are desired to have good abrasion properties. To achieve this, the resistance of the tread should be high. For truck tires, the selection of materials for incorporation into the tire is material-and combination-specific. Various rubber compositions have been proposed in which specific reinforcing fillers and additives are used to improve abrasion resistance.

Tradeoffs are typically accepted between properties to realize a desired performance characteristic. Therefore, improved abrasion is often realized to the detriment of other properties, such as hysteresis (or rolling resistance).

Here, a rubber compound is desired which displays improved abrasion resistance and rolling resistance. To meet this challenge, it was desired to balance a reinforcement network and evaluate a specific tripolymer blend reinforced with the same.

### SUMMARY OF THE INVENTION

One embodiment of the disclosure is directed to a sulfur-curable rubber composition comprising, based on 100 parts by weight of elastomer (phr):
(A) at least three diene elastomers each being a different rubber material, a first elastomer being characterized by a high molecular weight in a range of from about 300,000 to about 500,000 and a second elastomer being characterized by a molecular weight in the range of from about 250,000 to 350,000; the at least three elastomers each comprising between 25 and 40 phr; and
(B) a reinforcement network comprising a balance of carbon black to silica in about a 3:1 to about 4:1 ratio.

Another embodiment of the disclosure is a sulfur-curable rubber composition comprising, based on 100 parts by weight of elastomer (phr):
(A) at least two diene elastomers in a 1:1 ratio and each being a different rubber material, a first elastomer being a polybutadiene characterized by a higher molecular weight than a second elastomer, the second elastomer being a functional or non-functional solution polymerized styrene-butadiene rubber (SSBR);
(B) a third diene elastomer being a different rubber material than the first two diene elastomers, the third diene elastomer being in a minority amount;
(C) a reinforcement network comprising a balance of carbon black to silica in about a 3:1 to about 4:1 ratio; and
(D) a plasticizer in less than 5 phr.

A further embodiment of the disclosure is directed to a tire component incorporating the rubber composition.

An additional embodiment of the disclosure is directed to a passenger or truck tire incorporating the rubber composition.

### DETAILED DESCRIPTION OF THE INVENTION

The present disclosure is directed to a sulfur curable rubber composition, which comprises a tripolymer blend and a balanced reinforcement network. The disclosed rubber composition is desired for incorporation in vehicle tires to improve abrasion resistance and rolling resistance.

More specifically, the present disclosure is directed to a sulfur-curable (synonymous herein to “vulcanizable”) rubber composition comprising, based on 100 parts by weight of elastomer (phr):
(A) at least three diene elastomers each being a different rubber material, a first elastomer being characterized by a high molecular weight in a range of from about 300,000 to about 500,000 and a second elastomer being characterized by a molecular weight in the range of from about 250,000 to 350,000; the at least three elastomers each comprising between 25 and 40 phr; and
(B) a reinforcement network comprising a balance of carbon black to silica in about a 3:1 to about 4:1 ratio.

As used herein, a “reinforcement network” or “reinforcing network” is a filler system comprising a filler and an optional coupler (or coupling agent) that, in the presence of each other, vulcanizes or crosslinks with polymer(s) to form entangled networks.

As used herein, except where context requires otherwise, the term “comprise” and variations of the term, such as “comprising”, “comprises” and “comprised”, are not intended to exclude further additives, components, integers, or steps.

As used herein, the terms “rubber” and “elastomer” may be used interchangeably, unless otherwise prescribed. The terms “rubber composition,” “compounded rubber” and “rubber compound” are used interchangeably to refer to rubber which has been blended or mixed with various ingredients and materials and such terms are well known to those having skill in the rubber mixing or rubber compounding art.

### Rubber Elastomers

A critical aspect of the disclosed rubber compound is a tripolymer blend of conjugated diene-based elastomers. In practice, each elastomer is a different rubber material. Various rubber materials may be used for the rubber composition such as, for example, polymers and copolymers of at least one of isoprene and 1,3-butadiene and of styrene copolymerized with at least one of isoprene and 1,3-butadiene, and mixtures thereof.

Representative of such conjugated diene-based elastomers are, for example, comprised of at least one of cis 1,4-polyisoprene (natural and synthetic), cis 1,4-polybutadiene, styrene/butadiene copolymers (aqueous emulsion polymerization prepared and organic solvent solution polymerization prepared), medium vinyl polybutadiene having a vinyl 1,2-content in a range of about 15 to about 90 percent, isoprene/butadiene copolymers, styrene/isoprene/butadiene terpolymers.

The cis 1,4-polyisoprene and cis 1,4-polyisoprene natural rubber are well known to those having skill in the rubber art.

Representative synthetic polymers are the homopolymerization products of butadiene and its homologues and derivatives, for example, methylbutadiene, dimethylbutadiene and pentadiene as well as copolymers such as those formed from butadiene or its homologues or derivatives with other unsaturated monomers. Among the latter are acetylenes, for example, vinyl acetylene; olefins, for example, isobutylene, which copolymerizes with isoprene to form butyl rubber; vinyl compounds, for example, acrylic acid, acrylonitrile, which polymerize with butadiene to form NBR, methacrylic acid and styrene, the latter compound polymerizing with butadiene to form SBR, as well as vinyl esters and various unsaturated aldehydes, ketones and ethers, e.g., acrolein, methyl isopropenyl ketone and vinylethyl ether.

Specific examples of synthetic rubbers include neoprene (polychloroprene), polybutadiene (including cis-1,4-polybutadiene), polyisoprene (including cis-1,4polyisoprene), butyl rubber, halobutyl rubber such as chlorobutyl rubber or bromobutyl rubber, styrene/isoprene/butadiene rubber, copolymers of 1,3-butadiene or isoprene with monomers such as styrene, acrylonitrile and methyl methacrylate, as well as ethylene/propylene terpolymers, also known as ethylene/propylene/diene monomer (EPDM), and in particular, ethylene/propylene/dicyclopentadiene terpolymers. Additional examples of rubbers which may be used include alkoxy-silyl end functionalized solution polymerized polymers (SBR, PBR, IBR and SIBR), silicon-coupled and tin-coupled star-branched polymers.

In practice, the preferred rubber or elastomers are polyisoprene (natural or synthetic), polybutadiene and SBR. In practice, the rubber composition can comprise a high cis polybutadiene rubber and, preferably, a branched cis 1,4-poybutadiene rubber having a cis 1,4 content of at least 96% and which is considered herein to contain branches of pendant polybutadiene groups along its molecular chain. In practice, it is envisioned that the cis 1,4-polybutadiene elastomer may be a neodymium catalyst prepared cis 1,4-polybutadiene rubber which may be prepared, for example, by polymerization of 1,3-polybutadiene monomer in an organic solvent solution in the presence of a catalyst system comprising a neodymium compound, although other catalysts like nickel are envisioned too. Such a specialized polybutadiene would have a relatively high Mooney viscosity (ML 1+4) at 100° C. in its unvulcanized state in a range of from about 45 to about 75. In one embodiment, the polybutadiene rubber is characterized by a high molecular weight in a range of from about 300,000 to about 500,000. In certain embodiments, a polybutadiene with a lower molecular weight can be used to influence stiffness. In one embodiment, the polybutadiene rubber is characterized by a polydispersion (PDI) index of from about 2.0 to about 2.5.

Other embodiments are contemplated in which the polybutadiene is functionalized polybutadiene elastomer, which may be neodymium catalyst prepared.

In one embodiment, one elastomer is an SBR and, more preferably, a solution-polymerized SBR (SSBR). The SSBR can be conveniently prepared, for example, by organo lithium catalyzation in the presence of an organic hydrocarbon solvent.

In one embodiment, at least one elastomer, and preferably the SBR, is functionalized to react with a silica filler. Representative of functionalized elastomers are, for example, styrene/butadiene elastomers containing one or more functional groups comprised of
(A) amine functional group reactive with hydroxyl groups on precipitated silica,
(B) siloxy functional group, including end chain siloxy groups, reactive with hydroxyl groups on precipitated silica,
(C) combination of amine and siloxy functional groups reactive with hydroxyl groups on said precipitated silica,
(D) combination of thiol and siloxy (e.g. ethoxysilane) functional groups reactive with hydroxyl groups on the precipitated silica,
(E) combination of imine and siloxy functional groups reactive with hydroxyl groups on the precipitated silica,
(F) hydroxyl functional groups reactive with the precipitated silica.

For the functionalized elastomers, representatives of amine functionalized SBR elastomers are, for example, in-chain functionalized SBR elastomers mentioned in U.S. Pat. No. 6,936,669, the disclosure of which is incorporated herein in its entirety.

Representative of a combination of amino-siloxy functionalized SBR elastomers with one or more amino-siloxy groups connected to the elastomer is, for example, HPR355™ from JSR and amino-siloxy functionalized SBR elastomers mentioned in U.S. Pat. No. 7,981,966, the disclosure of which is incorporated herein in its entirety.

Representative styrene/butadiene elastomers end functionalized with a silane-sulfide group are, for example, mentioned in U.S. Pat. Nos. 8,217,103 and 8,569,409, the disclosures of which are incorporated herein in their entirety.

Organic solvent polymerization prepared tin coupled elastomers may also be used, such as, for example, tin coupled organic solution polymerization prepared styrene/butadiene copolymers, isoprene/butadiene copolymers, styrene/isoprene copolymers, polybutadiene and styrene/isoprene/butadiene terpolymers including the aforesaid functionalized styrene/butadiene elastomers.

Tin coupled copolymers of styrene/butadiene may be prepared, for example, by introducing a tin coupling agent during the styrene/1,3-butadiene monomer copolymerization reaction in an organic solvent solution, usually at or near the end of the polymerization reaction. Such coupling of styrene/butadiene copolymers is well known to those having skill in such art.

In practice, it is usually preferred that at least 50 percent and more generally in a range of about 60 to about 85 percent of the Sn (tin) bonds in the tin coupled elastomers are bonded to butadiene units of the styrene/butadiene copolymer to create Sn-dienyl bonds such as butadienyl bonds.

Creation of tin-dienyl bonds can be accomplished in a number of ways such as, for example, sequential addition of butadiene to the copolymerization system or use of modifiers to alter the styrene and/or butadiene reactivity ratios for the copolymerization. It is believed that such techniques, whether used with a batch or a continuous copolymerization system, is well known to those having skill in such art.

Various tin compounds, particularly organo tin compounds, may be used for the coupling of the elastomer. Representative of such compounds are, for example, alkyl tin trichloride, dialkyl tin dichloride, yielding variants of a tin coupled styrene/butadiene copolymer elastomer, although a trialkyl tin monochloride might be used which would yield simply a tin-terminated copolymer.

Examples of tin-modified, or coupled, styrene/butadiene copolymer elastomers might be found, for example and not intended to be limiting, in U.S. Pat. No. 5,064,901, the disclosure of which is incorporated herein in its entirety.

Emulsion polymerization prepared styrene/butadiene/acrylonitrile copolymer rubbers containing about 2 to about 40 weight percent bound acrylonitrile in the copolymer are also contemplated as diene-based rubbers for use in this invention.

By emulsion polymerization prepared E-SBR, it is meant that styrene and 1,3-butadiene are copolymerized as an aqueous emulsion. Such are well known to those skilled in such art. The bound styrene content can vary, for example, from about 5 to about 50 percent. In one aspect, the E-SBR may also contain acrylonitrile to form a terpolymer rubber, as E-SBAR, in amounts, for example, of about 2 to about 30 weight percent bound acrylonitrile in the terpolymer.

In practice, a specialized functionalized or non-functionalized SSBR would have a relatively high Mooney viscosity (ML 1+4) at 100° C. in its unvulcanized state in a range of from about 55 to 70. In one embodiment, the SSBR is characterized by a molecular weight that is lower than the molecular weight of the polybutadiene elastomer comprised in the same composition. In one embodiment, the SSBR can be characterized by a molecular weight that is in a range of from about 250,000 to about 350,000. In one embodiment, the SSBR can be characterized by a polydispersion (PDI) index of from about 1.5 to about 2.0. Further characterizing features of the SSBR can relate to softening point or glass transition temperature. In one embodiment, the SSBR can be characterized by a relatively Tg in a range of from about -80° C. to about -40° C.

It is further contemplated that, in certain embodiments, the rubber elastomer may be a butyl type rubber, particularly copolymers of isobutylene with a minor content of diene hydrocarbon(s), such as, for example, isoprene and halogenated butyl rubber.

In practice, however, a third elastomer comprised in the tripolymer blend is a polyisoprene. In the contemplated embodiment, the polyisoprene is present in a minority portion or amount relative each of the other elastomers. In one embodiment, the other two elastomers, individually or combined, represent a majority portion of the rubber composition. In one embodiment, the first two elastomers can be present in a balanced 1:1 phr ratio. In one embodiment, the all three elastomers can be present in nearly equal amounts (phr) +/- 5 phr. In practice, each of the at least three elastomers of the tripolymer blend can be present in an amount of from about 25 to about 40 phr and, more preferably, of from about 30 to about 35 phr.

### Reinforcement Network

A critical aspect of the present disclosure is a balanced filler system or reinforcement network. The filler system comprises at least carbon black and silica in combination. By “balanced”, the filler system contains amounts of carbon black to silica within select ranges. In one embodiment, the majority filler is carbon black. In one embodiment, the minority filler portion belongs to silica. In the contemplated embodiment, the reinforcement network comprises a balance of carbon black to silica in about a 3:1 to about 4:1 ratio.

In one example, the carbon black is present in the rubber compound in an amount no less than about 20 phr. In another example, the carbon black is present in an amount of no more than 80 phr. In yet another example, the carbon black may be present in an amount of from about 30 phr to about 60 phr and, more preferably, from about 40 phr to about 50 phr.

In one example, the silica is present in the rubber compound in an amount no less than about 5 phr. In another example, the silica is present in an amount of no more than 30 phr. In yet another example, the silica may be present in an amount of from about 10 phr to about 20 phr and, more preferably, from about 10 phr to about 15 phr.

Representative examples of carbon blacks include N110, N121, N134, N220, N231, N234, N242, N293, N299, S315, N326, N330, M332, N339, N343, N347, N351, N358, N375, N539, N550, N582, N630, N642, N650, N683, N754, N762, N765, N774, N787, N907, N908, N990 and N991. These carbon blacks have iodine absorptions ranging from 9 to 145 g/kg and DBP number ranging from 34 to 150 cm³/100 g.

Commonly employed carbon blacks can be used as a conventional filler. Representative examples of such carbon blacks include N110, N121, N134, N220, N231, N234, N242, N293, N299, S315, N326, N330, M332, N339, N343, N347, N351, N358, N375, N539, N550, N582, N630, N642, N650, N683, N754, N762, N765, N774, N787, N907, N908, N990 and N991. These carbon blacks have iodine absorptions ranging from 9 to 145 g/kg and DBP number ranging from 34 to 150 cm³/100 g.

The silica filler may be any suitable silica or a combination of any such silica. Commonly used siliceous pigments that are used in rubber compounding applications include pyrogenic and precipitated siliceous pigments (silica), as well as precipitated high surface area (“HSA”) silica and highly dispersive silica (“HDS”).

The conventional siliceous pigments preferably employed in this invention are precipitated silicas such as, for example, those obtained by the acidification of a soluble silicate, e.g., sodium silicate.

The precipitated silicas can be characterized, for example, by having a BET surface area, as measured using nitrogen gas, preferably in the range of about 40 to about 600, and more usually in a range of about 50 to about 300 square meters per gram. The BET method of measuring surface area is described in the Journal of the American Chemical Society, Volume 60, page 304 (1930). The conventional silica may also be typically characterized by having a dibutylphthalate (DBP) absorption value in a range of about 100 to about 400, and more usually about 150 to about 300. The conventional silica might be expected to have an average ultimate particle size, for example, in the range of 0.01 to 0.05 micron as determined by the electron microscope, although the silica particles may be even smaller, or possibly larger, in size.

Various commercially available silicas may be used, such as, only for example herein, and without limitation, silicas commercially available from PPG Industries under the Hi-Sil trademark with designations 210, 243, 315 etc.; silicas available from Rhodia, with, for example, designations of Z1165MP, Z165GR, Zeosil Premium® 200 MP and silicas available from Degussa AG with, for example, designations VN2 and VN3, etc.

When precipitated silica is a pre-hydrophobated precipitated silica, additional precipitated silica (non-pre-hydrophobated silica) and/or a coupling agent may optionally be added to the rubber composition.

Other fillers that may be used in the rubber composition include, but are not limited to, particulate fillers such as ultra-high molecular weight polyethylene (UHMWPE), particulate polymer gels such as those disclosed in U.S. Pat. Nos. 6,242,534; 6,207,757; 6,133,364; 6,372,857; 5,395,891; or 6,127,488, and plasticized starch composite filler such as that disclosed in U.S. Pat. No. 5,672,639, the disclosures of which are hereby incorporated by reference.

In one embodiment, the rubber composition may also include a coupling agent. In one embodiment, the rubber composition may comprise a silane coupling agent if the reinforcement filler comprises silica.

The silane coupling agent may be any suitable silane coupling agent, such as bis(ω-trialkoxyalkylsilyl) polysulfide, ω-mercaptoalkyl-trialkoxysilane, or combination thereof. In one example, the bis-(ω-trialkoxysilylalkyl) polysulfide has an average of from about 2 to about 4 connecting sulfur atoms in its polysulfidic bridge. In another example, the bis-(ω-trialkoxysilylalkyl) polysulfide has an average of from about 2 to about 2.6 connecting sulfur atoms in its polysuflidic bridge. In yet another example, the bis-(ω-trialkoxysilylalkyl)polysulfide has an average of from about 3.3 to about 3.8 connecting sulfur atoms in its polysulfidic bridge. The alkyl group of the silylalkyl moiety of the bis-(ω-trialkoxysilylalkyl)polysulfide may be a saturated C₂-C₆ alkyl group, e.g., a propyl group. In addition, at least one of the alkyl groups of the trialkoxy moiety of the bis-(ω-trialkoxysilylalkyl)polysulfide can be an ethyl group and the remaining alkyl groups of the trialkoxy moiety can be independently saturated C₂-C₁₈ alkyls. In another example, at least two of the alkyl groups of the trialkoxy moiety of the bis-(ω-trialkoxysilylalkyl) polysulfide are ethyl groups and the remaining alkyl group of the trialkoxy moiety is independently a saturated C₃-C₁₈ alkyl. In one example, the bis-(ω-trialkoxysilylalkyl) polysulfide coupling agent is bis-3-(triethoxysilylpropyl) tetrasulfide (“TESPD”). In another example, the bis-(ω-trialkoxysilylalkyl) Polysulfide coupling agent is bis-3-(triethoxysilylpropyl) tetrasulfide (“TESPT”). The ωmercaptoalkyltrialkoxysilane may have its mercapto moiety blocked from pre-reacting with hydroxyl groups (e.g., silanol groups) contained on the precipitated silica aggregates prior to unblocking the blocked mercapto moiety at an elevated temperature. In one example, the blocked ω-mercaptoalkyl-trialkoxysilane is NXT or NXT-LoV available from GE Silicones of Tarrytown, N.Y.

The silane coupling agent is present in the rubber compound in an amount no less than 10% by weight of silica. In another example, the silane coupling agent is present in an amount no more than about 20% by weight of silica.

The silane coupling agent may be present in an amount between from about 0 to about 10 phr and, more specifically, from about 0.5 to about 4 phr. The silane coupling agent may be present in the rubber compound in an amount no greater than 4 phr and, more specifically, 3 phr in some embodiments. In another example, the silane coupling agent may be present in an amount no less than about 1 phr and, in certain embodiments, 2 phr.

### Sulfur Curative

It may be preferred to have the rubber composition for use in the tire component to additionally contain a conventional sulfur containing organosilicon compound. Examples of suitable sulfur containing organosilicon compounds are of the formula:

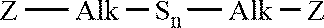

in which Z is selected from the group consisting of

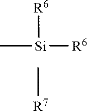

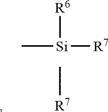

and

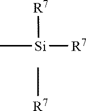

where R⁶ is an alkyl group of 1 to 4 carbon atoms, cyclohexyl or phenyl; R⁷ is alkoxy of 1 to 8 carbon atoms, or cycloalkoxy of 5 to 8 carbon atoms; Alk is a divalent hydrocarbon of 1 to 18 carbon atoms and n is an integer of 2 to 8.

Specific examples of sulfur containing organosilicon compounds which may be used in accordance with the present invention include: 3,3′-bis(trimethoxysilylpropyl) disulfide, 3,3′-bis (triethoxysilylpropyl) disulfide, 3,3′-bis(triethoxysilylpropyl) tetrasulfide, 3,3′-bis(triethoxysilylpropyl) octasulfide, 3,3′-bis(trimethoxysilylpropyl) tetrasulfide, 2,2′-bis(triethoxysilylethyl) tetrasulfide, 3,3′-bis(trimethoxysilylpropyl) trisulfide, 3,3′-bis(triethoxysilylpropyl) trisulfide, 3,3′-bis(tributoxysilylpropyl) disulfide, 3,3′-bis(trimethoxysilylpropyl) hexasulfide, 3,3′-bis(trimethoxysilylpropyl) octasulfide, 3,3′-bis(trioctoxysilylpropyl) tetrasulfide, 3,3′-bis(trihexoxysilylpropyl) disulfide, 3,3′-bis(tri-2″-ethylhexoxysilylpropyl) trisulfide, 3,3′-bis(triisooctoxysilylpropyl) tetrasulfide, 3,3′-bis(tri-t-butoxysilylpropyl) disulfide, 2,2′-bis(methoxy diethoxy silyl ethyl) tetrasulfide, 2,2′-bis(tripropoxysilylethyl) pentasulfide, 3,3′-bis(tricyclonexoxysilylpropyl) tetrasulfide, 3,3′-bis(tricyclopentoxysilylpropyl) trisulfide, 2,2′-bis(tri-2″-methylcyclohexoxysilylethyl) tetrasulfide, bis(trimethoxysilylmethyl) tetrasulfide, 3-methoxy ethoxy propoxysilyl 3′-diethoxybutoxy-silylpropyltetrasulfide, 2,2′-bis(dimethyl methoxysilylethyl) disulfide, 2,2′-bis(dimethyl sec.butoxysilylethyl) trisulfide, 3,3′-bis(methyl butylethoxysilylpropyl) tetrasulfide, 3,3′-bis(di t-butylmethoxysilylpropyl) tetrasulfide, 2,2′-bis(phenyl methyl methoxysilylethyl) trisulfide, 3,3′-bis(diphenyl isopropoxysilylpropyl) tetrasulfide, 3,3′-bis(diphenyl cyclohexoxysilylpropyl) disulfide, 3,3′-bis(dimethyl ethylmercaptosilylpropyl) tetrasulfide, 2,2′-bis(methyl dimethoxysilylethyl) trisulfide, 2,2′-bis(methyl ethoxypropoxysilylethyl) tetrasulfide, 3,3′-bis(diethyl methoxysilylpropyl) tetrasulfide, 3,3′-bis(ethyl di-sec. butoxysilylpropyl) disulfide, 3,3′-bis(propyl diethoxysilylpropyl) disulfide, 3,3′-bis(butyl dimethoxysilylpropyl) trisulfide, 3,3′-bis(phenyl dimethoxysilylpropyl) tetrasulfide, 3-phenyl ethoxybutoxysilyl 3′-trimethoxysilylpropyl tetrasulfide, 4,4′-bis(trimethoxysilylbutyl) tetrasulfide, 6,6′-bis(triethoxysilylhexyl) tetrasulfide, 12,12′-bis(triisopropoxysilyl dodecyl) disulfide, 18,18′-bis(trimethoxysilyloctadecyl) tetrasulfide, 18,18′-bis(tripropoxysilyloctadecenyl) tetrasulfide, 4,4′-bis(trimethoxysilyl-buten-2-yl) tetrasulfide, 4,4′-bis(trimethoxysilylcyclohexylene) tetrasulfide, 5,5′-bis(dimethoxymethylsilylpentyl) trisulfide, 3,3′-bis(trimethoxysilyl-2-methylpropyl) tetrasulfide, 3,3′-bis(dimethoxyphenylsilyl-2-methylpropyl) disulfide.

The preferred sulfur containing organosilicon compounds are the 3,3′-bis(trimethoxy or triethoxy silylpropyl) sulfides. The most preferred compounds are 3,3′-bis(triethoxysilylpropyl) disulfide and 3,3′-bis(triethoxysilylpropyl) tetrasulfide. Therefore, as to formula I, preferably Z is

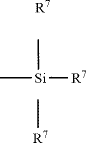

where R⁷ is an alkoxy of 2 to 4 carbon atoms, with 2 carbon atoms being particularly preferred; alk is a divalent hydrocarbon of 2 to 4 carbon atoms with 3 carbon atoms being particularly preferred; and n is an integer of from 2 to 5 with 2 and 4 being particularly preferred.In another embodiment, suitable sulfur containing organosilicon compounds include compounds disclosed in U.S. Pat. No. 6,608,125. In one embodiment, the sulfur containing organosilicon compounds includes 3-(octanoylthio)-1-propyltriethoxysilane, CH₃(CH₂)₆C(═O) —S—CH₂CH₂CH₂Si(OCH₂CH₃)₃, which is available commercially as NXT™ from Momentive Performance Materials.

In another embodiment, suitable sulfur containing organosilicon compounds include compounds disclosed in U.S. Publication 2006/0041063, the disclosure of which is incorporated herein by reference in its entirety. In one embodiment, the sulfur containing organosilicon compounds include the reaction product of hydrocarbon based diol (e.g., 2-methyl-1,3-propanediol) with S-[3-(triethoxysilyl)propyl] thiooctanoate. In one embodiment, the sulfur containing organosilicon compound is NXT-Z™ from Momentive Performance Materials.

In another embodiment, suitable sulfur containing organosilicon compounds include those disclosed in U.S. Pat. Publication No. 2003/0130535, which is incorporated herein by reference in its entirety. In one embodiment, the sulfur containing organosilicon compound is Si-363 from Degussa.

The amount of the sulfur containing organosilicon compound of formula I in a rubber composition will vary depending on the level of other additives that are used. The amount of the compound of formula I will range from 0.5 to 20 phr. Preferably, the amount will range from 1 to 10 phr.

### Oil

The rubber composition may include a small amount of rubber processing oil. The rubber composition can include from 0.1 to about 5 phr of processing oil. In one embodiment, the rubber composition can include more than 1 phr of processing oil. In one embodiment, the rubber composition can include less than 3 phr of processing oil. Processing oil may be included in the rubber composition as extending oil typically used to extend elastomers. Processing oil may also be included in the rubber composition by addition of the oil directly during rubber compounding. In the contemplated embodiment, the oil is freely added, although it may include both extending oil present in the elastomers and process oil added during compounding. In one embodiment, the rubber composition includes a low PCA oil. Suitable low PCA oils include, but are not limited to, mild extraction solvates (MES), treated distillate aromatic extracts (TDAE), residual aromatic extract (RAE), SRAE, and heavy napthenic oils as are known in the art; see, for example, U.S. Pat. Nos. 5,504,135; 6,103,808; 6,399,697; 6,410,816; 6,248,929; 6,146,520; U.S. Published Applications 2001/00023307; 2002/0000280; 2002/0045697; 2001/0007049; EP0839891; JP2002097369; ES2122917, the disclosures of which are hereby incorporated by reference.

Suitable low PCA oils include those having a polycyclic aromatic content of less than 3 percent by weight as determined by the IP346 method. Procedures for the IP346 method may be found in Standard Methods for Analysis & Testing of Petroleum and Related Products and British Standard 2000 Parts, 2003, 62nd edition, published by the Institute of Petroleum, United Kingdom.

Suitable TDAE oils are available as Tudalen® SX500 from Klaus Dahleke KG, VivaTec® 400 and VivaTec® 500 from H&R Group, and Enerthene® 1849 from BP, and Extensoil® 1996 from Repsol. The oils may be available as the oil alone or along with an elastomer in the form of an extended elastomer.

Suitable vegetable oils include, for example, soybean oil, sunflower oil, rapeseed oil, and canola oil which are in the form of esters containing a certain degree of unsaturation.

### Processing Aid—Fatty Acid Derivatives

A critical aspect of the present disclosure is the addition of a processing aid for the rubber composition. In a preferred embodiment, the processing aid can be a blend of fatty acid derivatives or a blend of fatty acid(s) and fatty acid derivative(s). The processing aid can have a softening point (Tg) in the range of from about 105° C. to about 120° C. Generally, from about 0.5 to about 5 phr and, more preferably, from about 1 to about 2 phr of processing aid may be comprised in the composition. In a contemplated embodiment, the processing aid be obtained as ZB 49 from Struktol® or others. In some embodiments, the processing aid can be used to promote coupling between a coupling agent, silica filler and/or moieties on the polymer to the network between the polymers.

### Additive

It is readily understood by those having skill in the art that the rubber composition would be compounded by methods generally known in the rubber compounding art, such as mixing the various sulfur-vulcanizable constituent rubbers with various commonly used additive materials such as, for example, sulfur donors, curing aids, such as activators, accelerators and retarders and processing additives, fillers, pigments, fatty acid, zinc oxide, waxes, antioxidants and antiozonants and peptizing agents. As known to those skilled in the art, depending on the intended use of the sulfur vulcanizable and sulfur-vulcanized material (rubbers), the additives mentioned above are selected and commonly used in conventional amounts. Representative examples of sulfur donors include elemental sulfur (free sulfur), an amine disulfide, polymeric polysulfide and sulfur olefin adducts. Preferably, the sulfur-vulcanizing agent is elemental sulfur. The sulfur-vulcanizing agent may be used in an amount ranging from 0.5 to 8 phr, with a range of from 1 to 6 phr being preferred. Typical amounts of antioxidants comprise about 0.5 to about 5 phr. Representative antioxidants may be, for example, polymerized trimethyl dihydroquinoline, mixture of aryl-p-phenylene diamines, and others, such as, for example, those disclosed in The Vanderbilt Rubber Handbook (1978), pages 344 through 346. Typical amounts of antiozonants comprise about 1 to 5 phr. A nonlimiting representative antiozonant can be, for example, N-(1,3 dimethyl butyl)-n′-phenyl-p-phenylenediamine. Typical amounts of fatty acids, if used, which can include stearic acid as an example, can comprise about 0.5 to about 5 phr. Typical amounts of waxes comprise about 1 to about 5 phr. Often microcrystalline waxes are used, but refined paraffin waxes or combinations of both can be used. Typical amounts of peptizers comprise about 0.1 to about 1 phr. Typical peptizers may be, for example, pentachlorothiophenol and dibenzamidodiphenyl disulfide.

Accelerators are used to control the time and/or temperature required for vulcanization and to improve the properties of the vulcanizate. In one embodiment, a single accelerator system may be used, i.e., primary accelerator. The primary accelerator(s) may be used in total amounts ranging from about 0.5 to about 6, preferably about 0.8 to about 4, phr. In another embodiment, combinations of a primary and a secondary accelerator might be used with the secondary accelerator being used in smaller amounts, such as from about 0.05 to about 3 phr, in order to activate and to improve the properties of the vulcanizate. Combinations of these accelerators might be expected to produce a synergistic effect on the final properties and are somewhat better than those produced by use of either accelerator alone. In addition, delayed action accelerators may be used which are not affected by normal processing temperatures but produce a satisfactory cure at ordinary vulcanization temperatures. Vulcanization retarders might also be used. A nonlimiting example of a retarder can be N-cyclohexylthiophthalimide (CTP). Suitable types of accelerators that may be used in the present invention are amines, disulfides, guanidines, thioureas, thiazoles, thiurams, sulfenamides, dithiocarbamates and xanthates. Preferably, the primary accelerator is a sulfenamide. If a second accelerator is used, the secondary accelerator is preferably a guanidine, dithiocarbamate or thiuram compound.

The mixing of the rubber composition can be accomplished by methods known to those having skill in the rubber mixing art. For example, the ingredients are typically mixed in at least two stages, namely, at least one non-productive stage followed by a productive mix stage. The final curatives including sulfur-vulcanizing agents are typically mixed in the final stage which is conventionally called the “productive” mix stage in which the mixing typically occurs at a temperature, or ultimate temperature, lower than the mix temperature(s) than the preceding non-productive mix stage(s). The terms “non-productive” and “productive” mix stages are well known to those having skill in the rubber mixing art. The rubber composition may be subjected to a thermomechanical mixing step. The thermomechanical mixing step generally comprises a mechanical working in a mixer or extruder for a period of time suitable in order to produce a rubber temperature between 140° C. and 190° C. The appropriate duration of the thermomechanical working varies as a function of the operating conditions, and the volume and nature of the components. For example, the thermomechanical working may be from 1 to 20 minutes.

Vulcanization of a pneumatic tire of the present invention is generally carried out at conventional temperatures ranging from about 100° C. to 200° C. Preferably, the vulcanization is conducted at temperatures ranging from about 110° C. to 180° C. Any of the usual vulcanization processes may be used such as heating in a press or mold, heating with superheated steam or hot air. Such tires can be built, shaped, molded and cured by various methods which are known and will be readily apparent to those having skill in such art.

The disclosure contemplates a tire component formed from such method. Similarly, the tire component may be incorporated in a tire. The tire component can be ground contacting or non-ground contacting. The tire can be pneumatic or non-pneumatic. In one embodiment, the tire component can be a tread.

The tire of the present disclosure may be a race tire, passenger tire, aircraft tire, agricultural, earthmover, off-the-road, truck (commercial or passenger) tire, and the like. Preferably, the tire is a passenger or truck tire. The tire may also be a radial or bias, with a radial being preferred.

The rubber composition itself, depending largely upon the selection of reinforcement network, may also be useful as a tire sidewall or other tire components or in rubber tracks, conveyor belts or other industrial product applications. Particularly, improved abrasion resistance offers advantages in a wide variety of rubber products, such as windshield wiper blades, brake diaphragms, washers, seals, gaskets, hoses, conveyor belts, power transmission belts, shoe soles, shoe foxing and floor mats for buildings or automotive applications.

The following examples are presented for the purposes of illustrating and not limiting the present invention. All parts are parts by weight unless specifically identified otherwise.

### Example 1

In this example, the effects on the performance of rubber compounds are illustrated for compounds comprising a tri-polymer blend and a filler system and coupling agent. In the Experimental sample, at least one diene elastomer contains functional groups that can interact with silica filler.

Rubber compounds were mixed in a multi-step mixing procedure following the recipes in Table 1. Standard amounts of additive materials and curing techniques were also used. The rubber compounds were then cured and tested for various properties including, inter alia, abrasion and hysteresis.

A control rubber compound was prepared as Control sample A using a tri-polymer blend of isoprene (natural rubber), polybutadiene, and SSBR. In Control A, a coupling agent is absent because the SSBR is non-functionalized.

For the Experimental sample B, a rubber compound was also prepared using a tri-polymer blend of isoprene (natural rubber), polybutadiene, and SSBR except that the SBR is functionalized. The Experiment B expanded the use of the tri-polymer blend to a compound incorporating a balanced reinforcement network or filler system having carbon black, silica, and a coupling agent. Standard amounts of accelerator were also used, with other ingredients being the same.

The basic formulations are illustrated in the following Table 1, which is presented in parts per 100 parts by weight of elastomers (phr).

TABLE 1

Samples

| | Control | Experimental |
|---|---|---|
| | A | B |
| Natural Rubber | 50 | 30 |
| F-SSBR¹ | 0 | 35 |
| Polybutadiene² | 0 | 35 |
| Polybutadiene³ | 25 | 0 |
| SSBR⁴ | 25 | 0 |
| Carbon Black | 55 | 47 |
| Wax⁵ | 1.5 | 1.5 |
| Processing Oil | 5 | 2 |
| Zinc Oxide | 3 | 3 |
| Stearic Acid | 2.5 | 2.5 |
| Silica | 0 | 14 |
| Coupling Agent⁶ | 0 | 2.5 |
| Protective Agents⁷ | 3 | 3.75 |
| Processing Aid⁸ | 0 | 1.45 |
| Sulfur | 1 | 1 |

¹SSBR, 15% styrene, Sn coupled, Tg -60° C.
²High cis 1,4-polybutadiene, Nd with Mooney viscosity of 55.0 (accd to ASTM D1646) obtained from the Goodyear Tire & Rubber Company
⁴SSBR, 18% styrene, Tg -70° C. obtained from the Goodyear Tire & Rubber Company
⁵Microcrystalline wax and refined paraffin wax
⁶Bifunctional organo-silane obtained as Si 69® from Evonik Industries
⁷Polymerized trimethyl dihydroquinoline and N-(1,3 dimethyl butyl)-N′-phenyl-p-phenylenediamine
⁸Blend of fatty acid derivatives obtained as ZB 49 from Struktol®

Various cured rubber properties of the Control sample A and the Experimental sample B are reported in the following Table 2.

TABLE 2

Samples

| | Control | Experimental |
|---|---|---|
| | A | B |
| Natural Rubber | 50 | 30 |
| F-SSBR¹ | 0 | 35 |
| Polybutadiene² | 0 | 35 |
| Polybutadiene³ | 25 | 0 |
| SSBR⁴ | 25 | 0 |
| RPA | | |
| G′ (0.83 Hz; 100° C.; 15%) (MPa) | 0.236 | 0.278 |
| G′ (1%, 100° C.; 1 Hz) (MPa) | 2.169 | 3.011 |
| G′ (10%; 100° C.; 15%) (MPa) | 1.283 | 1.948 |
| G′ (50%; 100° C.; 15%) (MPa) | 0.863 | 1.355 |
| Tan Delta (10%; 100° C.; 15%) | 0.162 | 0.123 |
| MDR 150° C. | | |
| Max Torque (dN·m) | 16.02 | 23.26 |
| Min Torque (dN·m) | 2.84 | 23.26 |
| Delta Torque (dN·M) | 13.18 | 20.14 |
| Final Torque (dN·M) | 15.22 | 23.21 |
| T25 (min) | 5.6 | 6.46 |
| T90 (min) | 12.61 | 18.02 |
| ZWICK Rebound | | |
| 0° C. | 35 | 41 |
| 23° C. | 42 | 47 |
| 100° C. | 54 | 61 |
| De Mattia | | |
| Rate (min/mm) | 17.33 | 23.00 |
| Dispergrader—CB | | |
| X Dispersion Index | 5.1 | 7.3 |
| Y Large Cluster Index | 8.8 | 9.7 |
| White surface area (%) | 7.1 | 4.8 |
| Average aggregate size | 9.8 | 8.2 |
| Dispersion (%) | 87.3 | 97.2 |
| SD Avg Agr Size Z% (%) | 79.6 | 86.3 |
| RT Tensile | | |
| 300% Modulus (MPa) | 9.2 | 13.5 |
| Tensile Strength | 19.6 | 18.4 |
| Elongation at Break (%) | 588 | 431 |
| Grosch Abrasion | | |
| ABRAS Rate CUST1 (meas) (mg/km) | 135 | 150 |
| ABRAS Rate CUST2 (meas) (mg/km) | 348 | 327 |
| ABRAS Rate CUST3 (meas) (mg/km) | 732 | 595 |
| ABRAS Rate CUST4 (meas) (mg/km) | 1517 | 1098 |
| ARES Rheometrics | | |
| G′ (1% strain; 60° C.; 10 Hz) (MPa) | 3.995 | 5.315 |
| G′ (10% strain, 60° C.; 10 Hz) (MPa) | 1.947 | 2.798 |
| Tan Delta (10% strain; 60° C.; 10 Hz) | 0.241 | 0.186 |

As can be seen in Table 2, the overall performance properties of the rubber compound B (utilizing the tri-polymer blend with the balanced reinforcement network) compared favorably with the performance properties of the Control A.

The Experimental compound B (having a higher molecular weight (see Mooney Viscosity) polybutadiene) demonstrates improved stiffness over the Control A. This is shown by higher G′ MPa values of RPA and ARES Rheometer across increasing strain percent. The Experimental compound B also provides an improved cut growth propagation as demonstrated by the De Mattia values.

Additionally, compound B demonstrates improved abradability values over Control A when measured across increasing severities using the Grosch abrasion test. Therefore, the results indicate that the disclosed compound improved abrasion resistance over the conventional compound (A).

Rebound is a measure of hysteresis of the compound when subject to loading. The rolling resistance indicator is based on the rebound measured at 100° C. Tan Delta of RPA is also an indicator of rolling resistance. It was observed that Experimental compound B (61) has a higher measured rebound than Control A (54) at 100° C. The Tan Delta of RPA of Experimental compound B (0.123) is also significantly lower than the Control A (0.162). Therefore, compound B demonstrates significantly improved hysteresis and, thus, lower rolling resistance over the conventional compound.

Also, the dispergrader test displays favorable values for the Experimental sample. This is believed to be a result of improved polymer-filler interaction, which may be a result of the fatty acid blend.

It is hereby concluded that the presently disclosed rubber compounds are useful for tire treads when such compounds comprise the disclosed tripolymer blend and reinforcing network.

Variations in the present invention are possible in light of the description of it provided herein. While certain representative embodiments and details have been shown for the purpose of illustrating the subject invention, it will be apparent to those skilled in this art that various changes and modifications can be made therein without departing from the scope of the subject invention. It is, therefore, to be understood that changes can be made in the particular embodiments described which will be within the full intended scope of the invention as defined by the following appended claims.

What is claimed is:

1. A sulfur-curable rubber composition comprising, based on 100 parts by weight of elastomer (phr):
(A) at least three diene elastomers each being a different rubber material, a first elastomer being characterized by a high molecular weight in a range of from about 300,000 to about 500,000 and a second elastomer being characterized by a molecular weight in the range of from about 250,000 to 350,000; the at least three elastomers each comprising between 25 and 40 phr; and
(B) a reinforcement network comprising a balance of carbon black to silica in about a 3:1 to about 4:1 ratio.

2. The sulfur curable rubber composition of claim 1, comprising:
from about 35 to about 60 phr of the carbon black; and
from about 10 to about 20 phr of the silica.

3. The sulfur curable rubber composition of claim 1, wherein a ratio of the phr of the first and second elastomers is about 1:1.

4. The sulfur curable rubber composition of claim 1, wherein at least one of the diene elastomers is functionalized; wherein the reinforcement network further comprises a silane coupler.

5. The sulfur curable rubber composition of claim 1, wherein the first elastomer is a polybutadiene.

6. The sulfur curable rubber composition of claim 5, wherein the polybutadiene is Nd catalyzed and is further characterized by a polydispersion index in a range from about 2.0 to about 2.5.

7. The sulfur curable rubber composition of claim 1, wherein the second elastomer is a styrene-butadiene rubber (SBR).

8. The sulfur curable rubber composition of claim 7, wherein the SBR is a functionalized, Sn-coupled SBR.

9. The sulfur curable rubber composition of claim 7, wherein the SBR is non-functionalized.

10. The sulfur curable rubber composition of claim 1, wherein the second elastomer comprises a Tg in a range of from about -80° C. to about -40° C.

11. The sulfur curable rubber composition of claim 1, wherein a third elastomer comprises a natural or synthetic polyisoprene.

12. The sulfur curable rubber composition of claim 1 further comprising N-cyclohexylthiophthalimide (CTP).

13. The sulfur curable rubber composition of claim 1 further comprising about a 1 phr to about a 5 phr blend of fatty acid and/or fatty acid derivatives.

14. The sulfur curable rubber composition of claim 1, wherein the rubber composition excludes a resin.

15. The sulfur curable rubber composition of claim 1, wherein the rubber composition comprises less than 5 phr of a processing oil, the processing oil being selected from a group consisting of: TDAE; napthanenic; vegetable triglyceride; a complex mixture of vegetable triglyceride oils; and combinations of the same.

16. The sulfur curable rubber composition of claim 1, wherein the rubber composition in incorporated into a tire component.

17. The sulfur curable rubber composition of claim 1, wherein the tire component is a tread or ground contacting component.

18. The sulfur curable rubber composition of claim 1, wherein the rubber composition in incorporated into a truck tire.

19. A tire component formed from a sulfur-curable rubber composition comprising, based on 100 parts by weight of elastomer (phr):
(A) at least two diene elastomers in a 1:1 ratio and each being a different rubber material, a first elastomer being a polybutadiene characterized by a higher molecular weight than a second elastomer, the second elastomer being a functional or non-functional solution polymerized styrene-butadiene rubber (SSBR);
(B) a third diene elastomer being a different rubber material than the first two diene elastomers, the third diene elastomer being in a minority amount;
(C) a reinforcement network comprising a balance of carbon black to silica in about a 3:1 to about 4:1 ratio; and
(D) a plasticizer in less than 5 phr.

20. The rubber composition of claim 19, wherein the polybutadiene has a molecular weight in a range of from about 300,000 to about 500,000 and the SSBR has a molecular weight in the range of from about 250,000 to 350,000; the at least three elastomers each comprising between 25 and 40 phr.
